(19) United States
(12) Patent Application Publication
(10) Pub. No.: US 2007/0113828 A1
(43) Pub. Date: May 24, 2007

(54) FUEL INJECTOR ISOLATING AND SEALING MEMBER

(76) Inventors: Carl E. Fonville, Ann Arbor, MI (US); Jeffrey J. Mantey, Washington, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/464,289

(22) Filed: Aug. 14, 2006

Related U.S. Application Data
(60) Provisional application No. 60/738,798, filed on Nov. 22, 2005.

(51) Int. Cl. F02M 61/14

(52) U.S. Cl. 123/470

(57) ABSTRACT

A fuel injector isolating and sealing member is provided having a sleeve portion defining a bore that is sufficiently configured to receive at least a portion of a fuel injector. Additionally, the fuel injector isolating and sealing member includes a flange portion extending inwardly from the sleeve portion. The flange portion is radially offset to bias the fuel injector within the bore. The fuel injector isolating and sealing member includes a core portion that is at least partially covered with an inner isolating and sealing layer and is at least partially covered with an outer isolating and sealing layer. The inner and outer isolating and sealing layers are preferably formed from fluorocarbon elastomeric polymer, while the core portion is preferably formed from stainless steel. An internal combustion engine and fuel injection system incorporating the disclosed isolating and sealing member is also provided.

### CROSS-REFERENCE TO RELATED APPLICATIONS

This application claims priority to U.S. Provisional Application No. 60/738,798 filed on Nov. 22, 2005.

### TECHNICAL FIELD

The present invention relates to fuel delivery systems for internal combustion engines.

### BACKGROUND OF THE INVENTION

Fuel delivery systems for internal combustion engines are available in many different varieties. One of the more common of which is the port fuel injection system. The port fuel injection system utilizes a plurality of fuel injectors each of which delivers a predetermined amount of fuel to the inlet port of an associated combustion chamber. In such systems, the fuel injectors are mounted in sockets or injector bosses of a manifold or fuel rail, which operates to communicate fuel to each of the injectors.

Recent advances in fuel delivery and combustion research has allowed direct injection, or DI, fuel delivery systems to increase in popularity. The DI fuel delivery system provides a fuel injector within the cylinder head of the internal combustion engine. The DI fuel injector operates to inject a predetermined amount of fuel, at a predetermined time, directly into the combustion chamber. Since the gas pressure within the combustion chamber is orders of magnitude greater than that of the intake port, the DI fuel rail and fuel injector operate at a much higher fuel pressure than similar components within the port fuel injection system. The DI fuel delivery system may enable higher peak power levels, improved fuel economy, and lower exhaust emissions. These beneficial aspects of the DI fuel delivery system are a result of precise metering of the fuel injected into the combustion chamber as well as improved intake airflow into the combustion chamber.

The fuel injectors of the DI fuel delivery system deliver fuel to the combustion chamber in metered pulses, which are timed to control the amount of fuel delivered and to coordinate such delivery with specific points of the operational cycle of the engine. The sequential energization of the fuel injectors may operate to induce pressure pulsations within the fuel rail, which may produce noise-producing vibrations. The transmission of the vibrational energy generated within the DI fuel delivery system to the engine structure may follow at least two paths, such as; from the fuel injector to the cylinder head and from the fuel rail to the respective attachment point, which is most likely the cylinder head.

### SUMMARY OF THE INVENTION

A fuel injector isolating and sealing member is provided for sealing and isolation of a fuel injector, such as a direct injection fuel injector. The isolating and sealing member includes a core portion having a sleeve portion defining a bore sufficiently configured to receive at least a portion of the fuel injector. A flange portion extends radially inwardly from the core portion and is sufficiently configured to bias the fuel injector within the bore. At least one of the core portion and the flange portion has at least one of an outer isolating and sealing layer and an inner isolating and sealing layer.

The sleeve portion may be generally cylindrical and the flange portion may have an axial offset operable to bias the fuel injector within the bore. Additionally, at least one of the inner and the outer isolating and sealing layers may be formed from one of a fluorocarbon elastomeric polymer material and a viscoelastic material, while the core portion may be formed from stainless steel. The fuel injector isolating and sealing member in combination with the fuel injector may be configured to be at least partially received within a cylinder head of an internal combustion engine. A fuel system and an internal combustion engine incorporating the disclosed fuel injection isolating and sealing member is also provided.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic sectional perspective view of a portion of an internal combustion engine illustrating a fuel delivery system consistent with the present invention;

FIG. 2 is a cut-away perspective view of a fuel injector isolating and sealing member; and

FIG. 2a is a cross-sectional view of the fuel injector isolating and sealing member taken along line A-A of FIG. 2.

### DESCRIPTION OF THE PREFERRED EMBODIMENTS

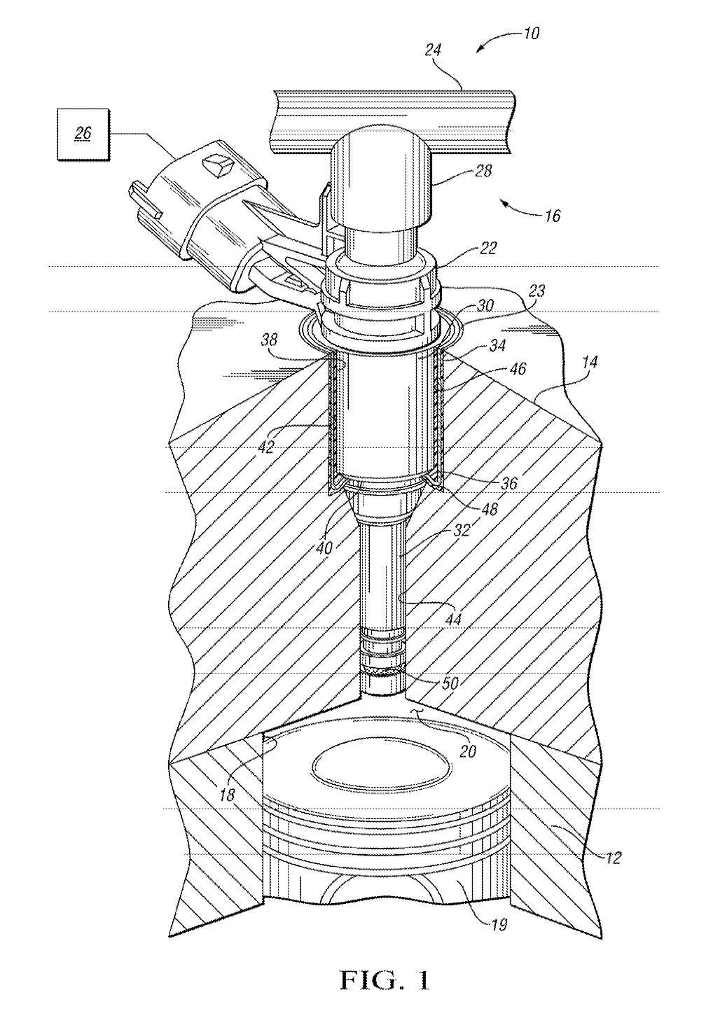

Referring to the figures wherein like reference numbers refer to like or similar components, there is shown in FIG. 1 a portion of an internal combustion engine, generally indicated at 10. The internal combustion engine 10 includes a cylinder case 12, cylinder head 14, and a fuel injection system 16. The cylinder case 12 defines a cylinder bore 18 within which a piston 19 is reciprocally movable. Although only one cylinder bore 18 is shown in FIG. 1, it should be apparent to those skilled in the art that the aspects taught by the present invention may be applied to engines having a plurality of cylinders bores 18 such as 4, 6, 8, 10, 12 and 16 cylinder engines. The cylinder head 14 is removably mounted with respect to the cylinder case 12, and cooperates with the cylinder bore 18 and the piston 19 to form variable volume combustion chamber 20. The internal combustion engine 10 shown in FIG. 1 is a direct injected, or DI, engine in that the fuel to be combusted is injected directly into the combustion chamber 20 by the fuel injection system 16.

The fuel injection system 16, in the preferred embodiment, includes a direct injection fuel injector 22, a fuel injector isolating and sealing member 23, a fuel rail 24, and an electronic control unit 26. The electronic control unit 26 includes a pre-programmable digital computer and operates to provide control signals to the fuel injector 22, thereby commanding the fuel injector 22 to deliver a predetermined amount of fuel at a specific point in the engine cycle. The fuel rail 24 acts as a conduit or manifold to deliver pressurized fuel to the fuel injector 22. The fuel rail 24 includes a mounting boss 28 sufficiently configured to receive one end of the fuel injector 22 and retain the fuel injector 22 in relation to the fuel rail 24. The fuel rail 24 in the preferred embodiment removably mounts the fuel injector 22 with respect to the cylinder head 14. The fuel injector 22 further includes a body or housing portion 30 having a tip portion 32 extending axially therefrom. The fuel injector isolating and sealing member 23 includes a generally cylindrical sleeve portion 34 having a flange portion 36 extending generally radially inwardly therefrom. The sleeve portion 34 defines a bore 38 sufficiently configured to receive the body portion 30 of the fuel injector 22, such that a radially inwardly extending surface 40 of the body portion 30 abuts the flange portion 36. The flange portion 36 is axially offset toward the bore 38.

The cylinder head 14 defines a stepped bore 42. The stepped bore 42 includes a generally cylindrical first bore portion 44 and a generally cylindrical second bore portion 46 coaxially disposed with respect to the first bore portion 44. A circumferential land 48 is provided intermediate the first and second bore portions 44 and 46. The stepped bore 42 is sufficiently configured to receive the fuel injector 22. More specifically, the first bore portion 44 is sufficiently configured such that the tip portion 32 can pass through the cylinder head 14 to communicate with the combustion chamber 20. Additionally, the second bore portion 46 is sufficiently configured to receive the body portion 30 of the fuel injector 22 with the fuel injector isolating and sealing member 23 mounted thereto. The circumferential land 48 operates as a means to locate the fuel injector 22 within the cylinder head 14. The axial offset nature of the flange portion 36 serves to bias the fuel injector 22, within the stepped bore 42, away from the circumferential land 48, and in so doing, provide a measure of compliance between the fuel injector 22 and the head 14. An annular combustion seal 50 is provided about the tip portion 32 to sealingly engage the first bore portion 44 to disallow pressurized gases within the combustion chamber 20 from traversing the stepped bore 42.

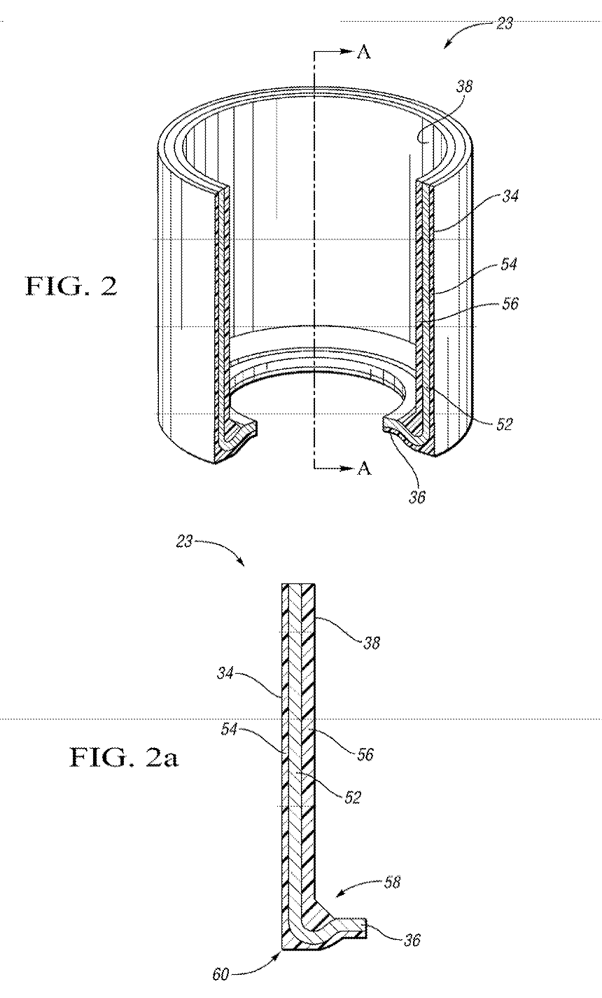

Referring to FIG. 2, and with further reference to FIG. 1, the structure of the fuel injector isolating and sealing member 23 will be described in greater detail. The fuel injector isolating and sealing member 23 includes a core portion 52 having an outer isolating and sealing layer 54 and an inner isolating and sealing layer 56 attached thereto. In the preferred embodiment, the inner and outer isolating and sealing layers 54 and 56 will be formed from a material with sufficient resistance to heat, abrasion, and fuel such as, for example, a fluorocarbon elastomeric polymer compound. However, those skilled in the art will recognize that other materials may be suitable for use, such as certain viscoelastic materials, while remaining within the scope of that which is claimed. The core portion 52 is preferably formed from stainless steel or any material with sufficient structural rigidity to resist significant deformation due to the insertion of the fuel injector 22 or the insertion of the fuel injector isolating and sealing member 23 into the cylinder head 14. Additionally, the material comprising the core portion 52 should be of sufficient stiffness to provide the necessary force to bias fuel injector 22 away from the circumferential land 48 during operation of the fuel injector 22. The core portion 52 should also be formed from a material having the sufficient stiffness to counteract the motion of the fuel injector 22 in a fully isolated fuel delivery system. Those skilled in the art will recognize that the core portion 52 may be formed from other materials such as aluminum, stainless steel, composites, etc. while remaining within the scope of that which is claimed.

FIG. 2a is a true cross sectional view of the fuel injector isolating and sealing member 23 taken along line A-A of FIG. 2. Those skilled in the art will recognize that the relative thicknesses of the core portion 52 and the inner and outer isolating and sealing layers 54 and 56 will depend on the application and the materials utilized therein. Additionally, FIG. 2a illustrates a generally annular first sealing portion 58 that operates to seal the fuel injector 22 to the fuel injector isolating and sealing member 23, and a generally annular second sealing portion 60 that operates to seal the fuel injector isolating and sealing member 23 to the cylinder head 14.

During operation of the internal combustion engine 10, it is desirable to disallow gases within the combustion chamber 20 from traversing the stepped bore 42. As state earlier, the combustion seal 50 operates to seal the stepped bore 42 from the combustion chamber 20. Additionally, a carbon dam may develop near the combustion seal 50 as a result of combustion of fuel within the combustion chamber 20. This carbon dam further blocks any egress of gases into the stepped bore 42. The combustion seal 50 and the carbon dam, although generally effective, may not totally seal the stepped bore 42 from combustion gases under certain engine operating conditions. Additionally, although the combustion seal 50 may be effective in static or non-isolated fuel delivery systems, the durability and sealing effectiveness of the combustion seal 50 may be reduced in a fully isolated fuel delivery system. As such, the fuel injector isolating and sealing member 23 and more specifically the first and second sealing portions 58 and 60 operate to further seal the stepped bore 42 from gases within the combustion chamber 20. This is especially beneficial for evaporative emission purposes.

The on/off or pulsating nature of the fuel injector 22, combined with the high fuel pressure present within the fuel rail 24 required to directly inject fuel into the combustion chamber 20 during operation of the engine 10, may transmit objectionable noise producing vibrations from the fuel injector 22 to the cylinder head 14 and other components of the engine 10. The fuel injector isolating and sealing member 23 operates to isolate these vibrations. The offset nature of the flange portion 36 adds compliance to the fuel injection system 16 by operating in a spring-like fashion similar to a conical spring. By biasing the fuel injector 22 away from the circumferential land 48, the fuel injector 22 will be less likely to ground to the cylinder head 14 thereby isolating the fuel injector 22 from the cylinder head 14. Additionally, the inner and outer isolating and sealing layers 54 and 56 provide a measure of isolation and vibration absorption to the fuel injector 22. The fuel injector isolating and sealing member 23 may also provide a measure of thermal insulation, such that heat energy from the cylinder head is less likely to be transmitted to the fuel within the fuel injector 22 and the fuel injection system 16.

The fuel injector isolating and sealing member 23 of the present invention may be installed within the fuel injection system 16 with little or no modification to the existing parts. Although the fuel injector isolating and sealing member 23 described in the preferred embodiment is generally cylindrical in nature, those skilled in the art will recognize that the fuel injector isolating and sealing member 23 may formed in other shapes while remaining within the scope of that which is claimed.

while the best modes for carrying out the invention have been described in detail, those familiar with the art to which this invention relates will recognize various alternative designs and embodiments for practicing the invention within the scope of the appended claims.

1. A fuel injector isolating and sealing member for sealing and isolation of a fuel injector, the isolating and sealing member comprising:
a core portion having a sleeve portion defining a bore sufficiently configured to receive the fuel injector;
a flange portion extending radially inwardly from said core portion, wherein said flange portion is sufficiently configured to bias the fuel injector within said bore; and
wherein at least one of said core portion and said flange portion has at least one of an outer isolating and sealing layer and an inner isolating and sealing layer.

2. The fuel injector isolating and sealing member of claim 1, wherein said sleeve portion is generally cylindrical and said flange portion has an axial offset operable to bias the fuel injector within said bore.

3. The fuel injector isolating and sealing member of claim 1, wherein the fuel injector is a direct injection fuel injector.

4. The fuel injector isolating and sealing member of claim 1, wherein at least one of said inner and said outer isolating and sealing layers is formed from a fluorocarbon elastomeric polymer material.

5. The fuel injector isolating and sealing member of claim 1, wherein at least one of said inner and said outer isolating and sealing layers is formed from a viscoelastic material.

6. The fuel injector isolating and sealing member of claim 1, wherein said core portion is formed from stainless steel.

7. The fuel injector isolating and sealing member of claim 1 in combination with the fuel injector, wherein the fuel injector and the fuel injector isolating and sealing member are configured to be at least partially disposed within a cylinder head of an internal combustion engine.

8. An internal combustion engine comprising:
a cylinder head defining a generally stepped bore, said generally stepped bore being sufficiently configured to receive a fuel injector,
a fuel injector isolating and sealing member disposed intermediate said fuel injector and said cylinder head;
wherein said fuel injector isolating and sealing member includes a sleeve portion defining a bore, said bore being sufficiently configured to receive said fuel injector; and
wherein said fuel injector isolating and sealing member includes a flange portion extending inwardly from said sleeve portion.

9. The internal combustion engine of claim 8, wherein said fuel injector is a direct injection fuel injector.

10. The internal combustion engine of claim 8, wherein said fuel injector isolating and sealing member includes a core portion, said core portion being at least partially covered within an inner isolating and sealing layer; and
wherein said core portion is at least partially covered with an outer isolating and sealing layer.

11. The internal combustion engine of claim 10, wherein at least one of said inner and said outer isolating and sealing layers is formed from a fluorocarbon elastomeric polymer material.

12. The internal combustion engine of claim 10, wherein at least one of said inner and said outer isolating and sealing layers is formed from a viscoelastic material.

13. The internal combustion engine of claim 8, wherein said generally stepped bore includes a land; and
wherein said flange portion is axially offset toward said bore defined by said sleeve portion such that said flange portion biases said fuel injector away from said land.

14. The internal combustion engine of claim 8, wherein said core portion is formed from stainless steel.

15. A fuel injection system comprising:
a fuel injector;
a fuel injector isolating and sealing member operable to substantially seal and substantially isolate said fuel injector, wherein said fuel injector isolating and sealing member includes:
a core portion having a generally cylindrical sleeve portion and defining a bore sufficiently configured to receive said fuel injector;
a flange portion extending radially inwardly from said core portion, wherein said flange portion has an axial offset operable to bias said fuel injector within said bore; and
wherein at least one of said core portion and said flange portion has at least one of an outer isolating and sealing layer and an inner isolating and sealing layer.

16. The fuel injection system of claim 15, wherein the fuel injector is a direct injection fuel injector.

17. The fuel injection system of claim 15, wherein at least one of said inner and said outer isolating and sealing layers is formed from one of a fluorocarbon elastomeric polymer material and a viscoelastic material.

18. The fuel injection system of claim 15, wherein said core portion is formed from stainless steel.

19. The fuel injection system of claim 15, wherein said fuel injector and said fuel isolating and sealing member are adapted to be at least partially disposed within a cylinder head of an internal combustion engine.
